(19) United States
(12) Patent Application Publication
(10) Pub. No.: US 2026/0028211 A1
(43) Pub. Date: Jan. 29, 2026

(54) SAFETY-ENHANCED HYDRAULIC METAL COIL LOADING SYSTEM AND METHOD THEREOF

(71) Applicant: Teofilo Montanez, Wayne, NJ (US)

(72) Inventor: Teofilo Montanez, Wayne, NJ (US)

(21) Appl. No.: 19/014,614

(22) Filed: Jan. 9, 2025

Related U.S. Application Data
(60) Provisional application No. 63/732,229, filed on Jul. 26, 2024.

(51) Int. Cl. B66F 9/04; B65H 16/02; B65H 18/04; B66F 9/18; B66F 9/19; B66F 17/00

(52) U.S. Cl. CPC B66F 9/04; B65H 16/02; B65H 18/04; B66F 9/187; B66F 9/19; B66F 17/00; B65H 2405/452; B65H 2407/10; B65H 2408/23; B65H 2408/24; B65H 2553/20; B65H 2557/22; B65H 2557/65; B65H 2701/173; B66F 2700/05

(57) ABSTRACT

The present disclosure relates to a safety-enhanced hydraulic metal coil loading system and method thereof (100) comprising a hydraulic lifting unit (102) configured to elevate metal coils, the hydraulic lifting unit (102) including a large hydraulic cylinder (104) and a small hydraulic cylinder (106), a positioning mechanism (110) mechanically linked to the hydraulic lifting unit (102), the positioning mechanism (110) including a lifter fork (112), a decoiler machine (116) operatively connected to the positioning mechanism (110), a support structure (118) comprising a frame and a carriage (120), a control unit (122) electrically coupled to the hydraulic lifting unit (102), positioning mechanism (110), and decoiler machine (116), the control unit (122) programmed to regulate lifting operations, monitor alignment, and prevent overload conditions, a monitoring interface (124) in communication with the control unit (122), a floor with a cutout cover (126) secured below the frame.

### FIELD OF THE INVENTION

Embodiments of the present invention relate to the field of industrial automation and specifically relates to a safety-enhanced hydraulic metal coil loading system and method thereof.

### DESCRIPTION OF THE RELATED ART

The invention minimizes physical risks by replacing the manual handling of heavy metal coils with a fully automated process. This proactive safety measure significantly reduces the chances of injuries caused by accidents such as slipping, improper lifting techniques, or sudden coil displacements, creating a safer environment for workers and fostering greater confidence in their daily tasks.

By automating the coil-loading process, this invention reduces the time and effort typically required for manual operations. This not only accelerates production cycles but also ensures consistent workflow without interruptions caused by human fatigue or errors, allowing businesses to meet demanding schedules and enhance overall output quality.

The design's robust stationary configuration guarantees dependable performance in demanding industrial settings. Its precision and automation ensure seamless loading and integration with other machinery, reducing operational hiccups. This reliability fosters long-term trust in the system's capability to handle repetitive tasks with accuracy and consistency.

Designed with simplicity in mind, the system does not require extensive technical training for operation. Its straightforward interface and automated functionalities enable workers to quickly adapt to the system, leading to a smoother transition from traditional manual methods while minimizing disruption to the existing workflow.

By reducing dependency on manual labor and lowering the risk of workplace injuries, this invention helps companies save significantly on labor costs and liability expenses. Additionally, its efficiency and durability reduce operational overhead, offering businesses a cost-efficient solution that promotes long-term profitability without compromising safety or productivity.

Many existing systems fail to incorporate advanced safety mechanisms, leaving workers vulnerable to injuries during the metal coil loading process. The absence of automated protective measures creates a hazardous work environment, especially in high-risk industrial settings. Additionally, the lack of standardized safety protocols further compromises worker well-being, increasing liability concerns for employers and impacting workforce morale.

Traditional designs often depend on manual labor for tasks like coil positioning and alignment, exposing workers to physical strain and potential accidents. This reliance on human effort not only slows down operations but also leads to inconsistencies in the process, as human errors can compromise precision. Moreover, repetitive physical tasks contribute to long-term health issues for workers, raising concerns about sustainability and workforce retention.

Many traditional systems are hindered by outdated mechanisms that struggle to meet modern production demands. Their slower operational speed results in frequent delays, bottlenecks, and reduced output, affecting overall productivity. Furthermore, these inefficiencies often force industries to rely on supplementary equipment or additional labor, increasing operational costs and reducing profitability over time.

Existing inventions frequently involve complex, outdated designs prone to mechanical failures and breakdowns. These recurring issues require frequent repairs and maintenance, significantly increasing operational expenses. The lack of durable components and straightforward maintenance procedures also leads to prolonged downtimes, disrupting production schedules and reducing overall efficiency in industrial processes.

In conclusion, while similar inventions attempt to address metal coil loading challenges, they fall short in crucial areas such as safety, efficiency, and cost-effectiveness. The dependence on manual intervention, lack of advanced safety features, and high maintenance demands highlights significant drawbacks in existing designs. The present invention overcomes these limitations by introducing a system and method that prioritizes worker safety, operational efficiency, and sustainability, making it a superior solution for modern industrial applications.

Thus, there is a need of a safety-enhanced hydraulic metal coil loading system and method thereof.

Therefore, the present invention provides a safety-enhanced hydraulic metal coil loading system and method thereof.

### SUMMARY OF THE INVENTION

Embodiments of the present invention relate to a safety-enhanced hydraulic metal coil loading system, the system. The system comprising a hydraulic lifting unit configured to elevate metal coils, the hydraulic lifting unit including a large hydraulic cylinder and a small hydraulic cylinder to enable precise lifting and lowering motions. The system also comprises a positioning mechanism mechanically linked to the hydraulic lifting unit, the positioning mechanism including a lifter fork for securing and aligning the metal coils along predetermined axes. The system also comprises a decoiler machine operatively connected to the positioning mechanism, the decoiler machine configured to support and uncoil the metal coils for further processing. The system also comprises a support structure comprising a frame and a carriage, the support structure configured to stabilize and transport the metal coils during operation. The system also comprises a control unit electrically coupled to the hydraulic lifting unit, positioning mechanism, and decoiler machine, the control unit programmed to regulate lifting operations, monitor alignment, and prevent overload conditions. The system also comprises a monitoring interface in communication with the control unit, the monitoring interface configured to provide real-time feedback on operational parameters, including load weight, positioning accuracy, and safety status. The system also comprises a floor with a cutout cover secured below the frame to enhance system stability and facilitate coil positioning during loading operations.

In accordance with an embodiment of the hydraulic lifting unit incorporates pressure sensors that relay real-time data to the control unit to optimize lifting performance.

In accordance with an embodiment of the present invention, the lifter fork includes motorized clamps adjustable for various coil dimensions, controlled via the monitoring interface.

In accordance with an embodiment of the present invention, the decoiler machine is integrated with sensors to detect coil alignment and synchronize with the positioning mechanism for seamless operation.

In accordance with an embodiment of the present invention, the support structure includes a carriage equipped with shock absorbers to dampen vibrations during operation.

In accordance with an embodiment of the present invention, the control unit includes a wireless interface for remote operation and diagnostics.

In accordance with an embodiment of the present invention, the monitoring interface is a touchscreen panel displaying safety alerts, alignment metrics, and system diagnostics.

In accordance with an embodiment of the present invention, the hydraulic lifting unit is integrated with a fail-safe mechanism to lock the system in position during emergencies.

In accordance with an embodiment of the present invention, the control unit is configured to autonomously adjust hydraulic pressure, lifter fork positioning, and decoiler machine operations based on pre-programmed parameters to ensure optimal performance.

In accordance with an embodiment of the present invention, the floor and cutout cover are integrated with guide rails to assist in precisely aligning the carriage and frame during coil positioning and lifting operations, enabling enhanced stability and reducing operational errors.

In accordance with an embodiment of the present invention, the lifter fork includes integrated load sensors that communicate with the control unit to adjust the lifting force dynamically, preventing coil deformation during handling.

In accordance with an embodiment of the present invention, the large hydraulic cylinder incorporates an energy recovery mechanism that stores excess hydraulic pressure generated during descent for reuse, increasing system energy efficiency.

In accordance with an embodiment of the present invention, the decoiler machine is operatively connected to a medium hydraulic cylinder, enabling synchronized movements to support seamless uncoiling and transfer of the metal coils.

In accordance with an embodiment of the present invention, the control unit employs an artificial intelligence-based algorithm to analyse real-time operational data, including sensor feedback, to optimize hydraulic pressure and adjust the positioning mechanism for variable coil sizes.

Another embodiment of the present invention relates to a safety-enhanced hydraulic metal coil loading method. The method includes operating a hydraulic lifting unit, comprising a large hydraulic cylinder and a small hydraulic cylinder, to precisely lift and lower metal coils. The method also includes aligning the metal coils using a positioning mechanism comprising a lifter fork, wherein the lifter fork secures and aligns the metal coils along predetermined axes. The method also includes uncoiling the metal coils via a decoiler machine operatively connected to the positioning mechanism to synchronize coil alignment and uncoiling. The method also includes transporting the metal coils on a support structure, including a frame and carriage, to stabilize the coils during lifting and uncoiling operations. The method also includes controlling the lifting, positioning, and uncoiling processes using a control unit that regulates hydraulic pressure, monitors coil alignment, and prevents overload conditions. The method also includes monitoring operational parameters through a monitoring interface, providing real-time feedback on load weight, alignment accuracy, and system safety.

In accordance with an embodiment of the present invention, the method further comprises the step of dynamically adjusting the lifting force of the hydraulic lifting unit based on feedback from integrated load sensors in the lifter fork, preventing coil deformation.

In accordance with an embodiment of the present invention, the method further comprises storing and reusing excess hydraulic pressure from the large hydraulic cylinder during descent, via an energy recovery mechanism, to enhance energy efficiency.

In accordance with an embodiment of the present invention, the method further comprises analysing real-time operational data through the control unit employing an artificial intelligence-based algorithm, optimizing hydraulic pressure and positioning for variable coil sizes.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1 illustrates a block diagram of the safety-enhanced hydraulic metal coil loading system, in accordance with an embodiment of the present invention;

FIG. 2 illustrates a perspective view of the safety-enhanced hydraulic metal coil loading system, in accordance with an embodiment of the present invention;

FIG. 3A to 3K illustrates a perspective view of each of the individual parts of the safety-enhanced hydraulic metal coil loading system, in accordance with an embodiment of the present invention;

FIG. 4 illustrates a flowchart of a safety-enhanced hydraulic metal coil loading system, in accordance with an embodiment of the present invention;

FIG. 5 illustrates a flowchart of a safety-enhanced hydraulic metal coil loading method, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE INVENTION

In the following detailed description, numerous specific details are set forth in order to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### The Following Brief Definition of Terms Shall Apply Throughout the Present Invention

The terms “determining”, “measuring”, “evaluating”, “assessing,” “assaying,” and “analyzing” can be used interchangeably herein to refer to any form of measurement, and include determining if an element is present or not. (e.g., detection). These terms can include both quantitative and/or qualitative determinations. Assessing may be relative or absolute.

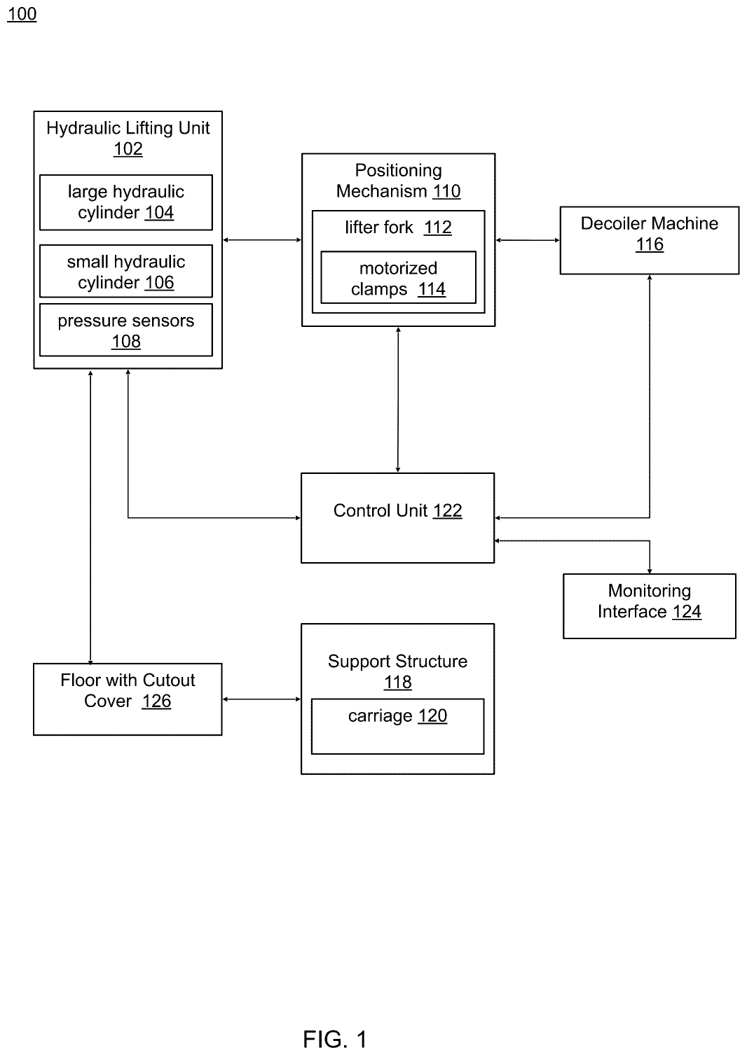

FIG. 1 illustrates a block diagram of the safety-enhanced hydraulic metal coil loading system 100, in accordance with an embodiment of the present invention.

The system 100 may comprise a hydraulic lifting unit 102 configured to elevate metal coils, the hydraulic lifting unit 102 including a large hydraulic cylinder 104 and a small hydraulic cylinder 106 to enable precise lifting and lowering motions. The system 100 may include a positioning mechanism 110 mechanically linked to the hydraulic lifting unit 102, the positioning mechanism 110 including a lifter fork 112 for securing and aligning the metal coils along predetermined axes. The system 100 may include a decoiler machine 116 operatively connected to the positioning mechanism 110, the decoiler machine 116 configured to support and uncoil the metal coils for further processing. The system 100 may include a support structure 118 comprising a frame and a carriage 120, the support structure 118 configured to stabilize and transport the metal coils during operation. The system 100 may include a control unit 122 electrically coupled to the hydraulic lifting unit 102, positioning mechanism 110, and decoiler machine 116, the control unit 122 programmed to regulate lifting operations, monitor alignment, and prevent overload conditions. The system 100 may include a monitoring interface 124 in communication with the control unit 122, the monitoring interface 124 configured to provide real-time feedback on operational parameters, including load weight, positioning accuracy, and safety status. The system 100 may include a floor with a cutout cover 126 secured below the frame to enhance system stability and facilitate coil positioning during loading operations.

The hydraulic lifting unit 102 incorporates pressure sensors 108 that relay real-time data to the control unit 122 to optimize lifting performance.

The lifter fork 112 includes motorized clamps 114 adjustable for various coil dimensions, controlled via the monitoring interface 124.

The decoiler machine 116 is integrated with sensors to detect coil alignment and synchronize with the positioning mechanism 110 for seamless operation.

The support structure 118 includes a carriage 120 equipped with shock absorbers to dampen vibrations during operation.

The control unit 122 includes a wireless interface for remote operation and diagnostics.

The monitoring interface 124 is a touchscreen panel displaying safety alerts, alignment metrics, and system diagnostics.

The hydraulic lifting unit 102 is integrated with a fail-safe mechanism to lock the system in position during emergencies.

The control unit 122 is configured to autonomously adjust hydraulic pressure, lifter fork 112 positioning, and decoiler machine 116 operations based on pre-programmed parameters to ensure optimal performance.

The floor with a cutout cover 126 is integrated with guide rails to assist in precisely aligning the carriage 120 and frame during coil positioning and lifting operations, enabling enhanced stability and reducing operational errors.

The lifter fork 112 includes integrated load sensors that communicate with the control unit 122 to adjust the lifting force dynamically, preventing coil deformation during handling.

The large hydraulic cylinder 104 incorporates an energy recovery mechanism that stores excess hydraulic pressure generated during descent for reuse, increasing system energy efficiency.

The decoiler machine 116 is operatively connected to a medium hydraulic cylinder, enabling synchronized movements to support seamless uncoiling and transfer of the metal coils.

The control unit 122 employs an artificial intelligence-based algorithm to analyze real-time operational data, including sensor feedback, to optimize hydraulic pressure and adjust the positioning mechanism 110 for variable coil sizes.

The method 100 may comprise operating a hydraulic lifting unit 102, comprising a large hydraulic cylinder 104 and a small hydraulic cylinder 106, to precisely lift and lower metal coils. The method 100 may include aligning the metal coils using a positioning mechanism 110 comprising a lifter fork 112, wherein the lifter fork 112 secures and aligns the metal coils along predetermined axes. The method 100 may also include uncoiling the metal coils via a decoiler machine 116 operatively connected to the positioning mechanism 110 to synchronize coil alignment and uncoiling. The method 100 may also include transporting the metal coils on a support structure 118, including a frame and carriage 120, to stabilize the coils during lifting and uncoiling operations. The method 100 may also include controlling the lifting, positioning, and uncoiling processes using a control unit 122 that regulates hydraulic pressure, monitors coil alignment, and prevents overload conditions. The method 100 may also include monitoring operational parameters through a monitoring interface 124, providing real-time feedback on load weight, alignment accuracy, and system safety.

The method further comprises the step of dynamically adjusting the lifting force of the hydraulic lifting unit 102 based on feedback from integrated load sensors in the lifter fork 112, preventing coil deformation.

The method further comprises storing and reusing excess hydraulic pressure from the large hydraulic cylinder 104 during descent, via an energy recovery mechanism, to enhance energy efficiency.

The method further comprises analyzing real-time operational data through the control unit 122 employing an artificial intelligence-based algorithm, optimizing hydraulic pressure and positioning for variable coil sizes.

The hydraulic lifting unit 102 comprises interconnected components that ensure efficient elevation of metal coils. The hydraulic lifting unit 102 includes a large hydraulic cylinder 104, a small hydraulic cylinder 106, and pressure sensors 108, all functioning in harmony. The hydraulic lifting unit 102 integrates seamlessly with the positioning mechanism 110 and control unit 122, ensuring optimal coordination during operation. The hydraulic lifting unit 102 lifts heavy loads while maintaining precision, allowing for stable and efficient material handling in industrial processes. This interconnected system ensures smooth transitions between loading, positioning, and further processing.

The large hydraulic cylinder 104 is integral to the hydraulic lifting unit 102, designed to generate substantial lifting force required for heavy-duty operations. The large hydraulic cylinder 104 is controlled by input signals from the control unit 122, ensuring precise lifting movements and maintaining stability. The large hydraulic cylinder 104 also works with pressure sensors 108 to monitor and regulate pressure dynamically. The large hydraulic cylinder 104's robust construction allows it to handle high loads, making it indispensable for industrial applications involving heavy metal coils.

The small hydraulic cylinder 106 within the hydraulic lifting unit 102 complements the functionality of the large hydraulic cylinder 104 by enabling fine adjustments in lifting operations. The small hydraulic cylinder 106 enhances positioning precision, particularly for delicate tasks requiring alignment. The small hydraulic cylinder 106 receives commands from the control unit 122, ensuring synchronized operations. The small hydraulic cylinder 106 is instrumental in achieving the intricate movement required for precise handling and positioning of metal coils during manufacturing processes.

The pressure sensors 108 are embedded in the hydraulic lifting unit 102 to continuously monitor pressure levels in the large hydraulic cylinder 104 and the small hydraulic cylinder 106. The pressure sensors 108 transmit real-time data to the control unit 122, which adjusts operations to ensure safety and efficiency. The pressure sensors 108 prevent overloading and maintain system stability, making them crucial for reliable operations. The pressure sensors 108 enable the hydraulic lifting unit 102 to adapt dynamically to varying loads and conditions, improving overall performance.

The positioning mechanism 110 connects to the hydraulic lifting unit 102 and includes a lifter fork 112 and motorized clamps 114. The positioning mechanism 110 aligns metal coils accurately for further processing. The positioning mechanism 110 works closely with the control unit 122 to ensure precise positioning and stability. The positioning mechanism 110's design facilitates seamless interaction with the decoiler machine 116, enhancing system efficiency. The positioning mechanism 110 optimizes material handling by reducing errors and improving productivity.

The lifter fork 112, part of the positioning mechanism 110, serves as a stable platform for holding metal coils during lifting and positioning operations. The lifter fork 112 interacts with the motorized clamps 114 to secure loads while receiving instructions from the control unit 122. The lifter fork 112 ensures stability, especially during transitions between different phases of handling. The lifter fork 112 is essential for maintaining the integrity of the material and ensuring operational safety.

The motorized clamps 114 in the positioning mechanism 110 secure metal coils with adjustable settings. The motorized clamps 114 work under the guidance of the control unit 122, adapting to various sizes and shapes of metal coils. The motorized clamps 114 ensure stability and alignment, minimizing the risk of material displacement during operation. The motorized clamps 114 are designed for durability and precision, contributing significantly to the overall system's reliability.

The decoiler machine 116 interacts with the positioning mechanism 110 and facilitates the uncoiling of metal coils. The decoiler machine 116 operates in synchronization with the control unit 122 to ensure smooth and consistent feeding of material for further processing. The decoiler machine 116 enhances efficiency by automating the uncoiling process, reducing manual intervention. The decoiler machine 116's integration with other system components ensures streamlined operations.

The support structure 118 stabilizes the hydraulic lifting unit 102 and positioning mechanism 110. The support structure 118 includes a large hydraulic cylinder 120, which aids in maintaining balance and facilitating transitions. The support structure 118 is designed to withstand the forces exerted by the hydraulic lifting unit 102, ensuring durability and stability. The support structure 118 provides a solid foundation, improving the system's overall reliability.

The carriage 120, housed within the support structure 118, plays a pivotal role in the system by ensuring the smooth and stable movement of metal coils during various operational phases. The carriage 120 is meticulously engineered to interact seamlessly with the hydraulic lifting unit 102, the positioning mechanism 110, and the decoiler machine 116, ensuring coordinated movement and load handling. The carriage 120 is equipped with shock-absorbing mechanisms to dampen vibrations and protect the integrity of metal coils during transport and positioning operations. Constructed from high-strength materials, the carriage 120 is designed to withstand significant loads while maintaining durability and precision in demanding industrial environments.

The carriage 120 is integrated with alignment aids, such as guide rails and sensors, to facilitate precise positioning of metal coils along predetermined axes. These alignment features allow the carriage 120 to work in conjunction with the lifter fork 112 and motorized clamps 114 within the positioning mechanism 110 to ensure accuracy and efficiency. The carriage 120 communicates with the control unit 122, receiving commands to adjust its movement dynamically based on real-time operational data. This feedback loop allows the carriage 120 to respond to system inputs with precision, contributing to the system's overall functionality and safety.

The control unit 122 acts as the central processing hub, coordinating the functions of the hydraulic lifting unit 102, positioning mechanism 110, and decoiler machine 116. The control unit 122 processes input from the pressure sensors 108 and motorized clamps 114, optimizing system performance. The control unit 122 ensures synchronization among all components, improving reliability and efficiency.

The monitoring interface 124 provides real-time data on system operations. The monitoring interface 124 displays critical information such as pressure levels, positioning accuracy, and operational safety. The monitoring interface 124 enables operators to make informed adjustments, ensuring smooth operations and preventing potential issues.

The floor with cutout cover 126 supports the entire system, providing a stable base for the support structure 118 and other components. The floor with cutout cover 126 facilitates precise alignment during metal coil handling, enhancing overall system efficiency. The floor with cutout cover 126 is designed for durability and reliability, making it an essential part of the system's infrastructure.

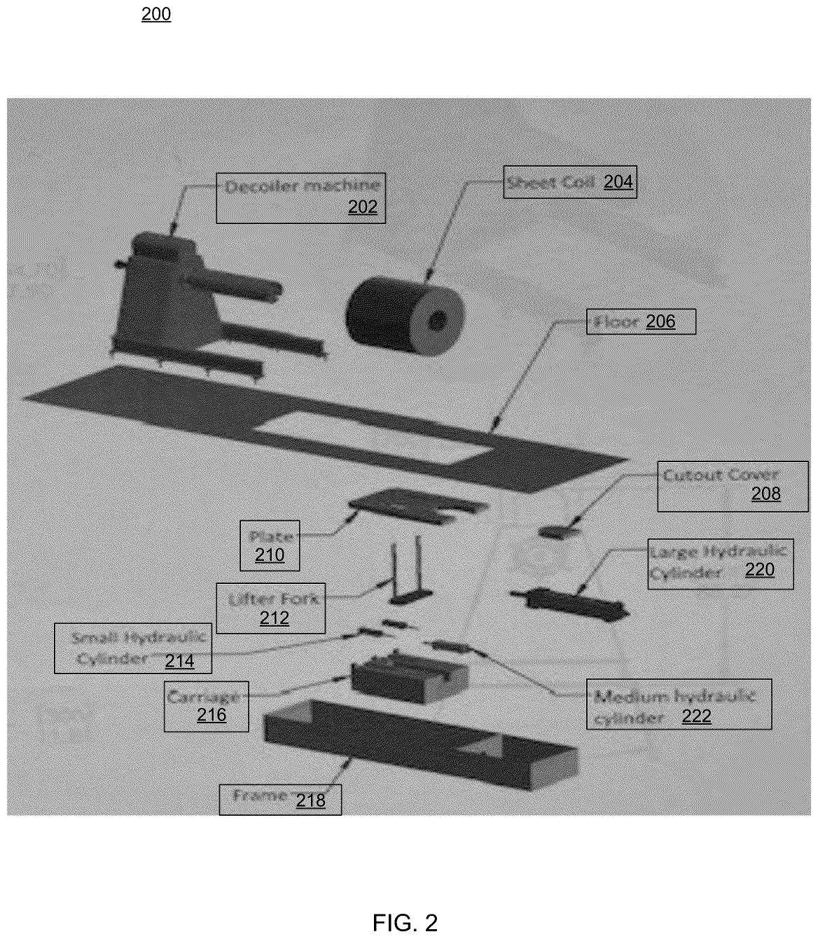

FIG. 2 illustrates a perspective view of the safety-enhanced hydraulic metal coil loading system, in accordance with an embodiment of the present invention.

The decoiler machine 202 ensures controlled uncoiling of the sheet coil 204, maintaining precise alignment for seamless processing. The decoiler machine 202 securely holds the sheet coil 204, enabling efficient material handling during system operations. The construction of the decoiler machine 202 is robust, providing stability and ensuring compatibility with various coil sizes, facilitating a smooth and safe uncoiling process.

The sheet coil 204, held by the decoiler machine 202, undergoes uncoiling for subsequent operations. The sheet coil 204 is manufactured with material properties and dimensions that ensure its structural integrity during processing. The sheet coil 204 allows for uninterrupted functionality, aligning seamlessly with the operational requirements of the system.

The floor 206 provides foundational support, maintaining stability for all components in the system. The floor 206 integrates with the frame 218, minimizing vibrations and enhancing the operational durability of the system. The smooth surface of the floor 206 facilitates precise movements of the carriage 216, optimizing the material handling process.

The cutout cover 208, positioned on the floor 206, enhances operational safety by covering specific sections and preventing misalignment or accidental exposure to underlying mechanisms. The cutout cover 208 is designed to accommodate system functionality while ensuring structural consistency with the floor 206, contributing to safety during coil handling.

The plate 210 aligns and stabilizes the lifter fork 212 during system operation. The plate 210 is constructed to withstand operational stresses, ensuring consistent performance during material lifting processes. The plate 210 integrates seamlessly with adjacent components, enhancing system efficiency and maintaining alignment during repeated cycles.

The lifter fork 212 facilitates secure lifting and positioning of the sheet coil 204 during uncoiling operations. The lifter fork 212 is precision-engineered to handle varying coil sizes and weights, working in conjunction with the hydraulic cylinders for controlled movement. The lifter fork 212 enhances overall system safety and efficiency by ensuring secure material handling.

The small hydraulic cylinder 214 provides controlled force to adjust the lifter fork 212 for precise positioning. The small hydraulic cylinder 214 operates in synchronization with other components to achieve fine-tuned movements. The construction of the small hydraulic cylinder 214 ensures durability and consistent performance under diverse operating conditions.

The carriage 216 transports and stabilizes the sheet coil 204 within the system. The carriage 216 integrates with the frame 218 for smooth and vibration-free movements. The carriage 216 features shock-absorbing mechanisms that prevent coil deformation and enhance stability, ensuring safe and efficient operation.

The frame 218 forms the structural base, supporting all components and maintaining stability during heavy operational loads. The frame 218 aligns with the floor 206 and carriage 216, ensuring the precise arrangement of components and contributing to the system's safety and functionality.

The large hydraulic cylinder 220 generates the lifting force required for handling the sheet coil 204. The large hydraulic cylinder 220 operates with high precision, enabling controlled lifting and lowering of the lifter fork 212. The construction of the large hydraulic cylinder 220 ensures reliable and efficient operation, enhancing system safety and durability.

The medium hydraulic cylinder 222 supports uncoiling and transportation by synchronizing movements between the lifter fork 212 and the decoiler machine 202. The medium hydraulic cylinder 222 incorporates advanced pressure control mechanisms for smooth and efficient material handling. The medium hydraulic cylinder 222 ensures stability and operational reliability, contributing significantly to system performance.

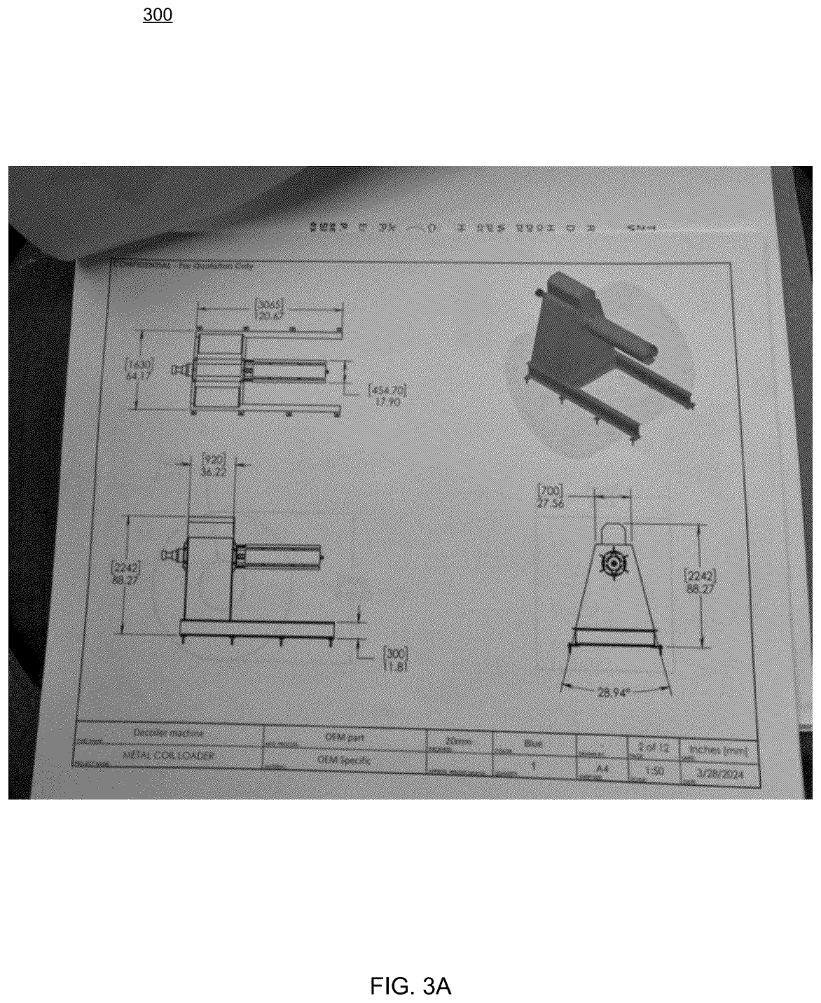

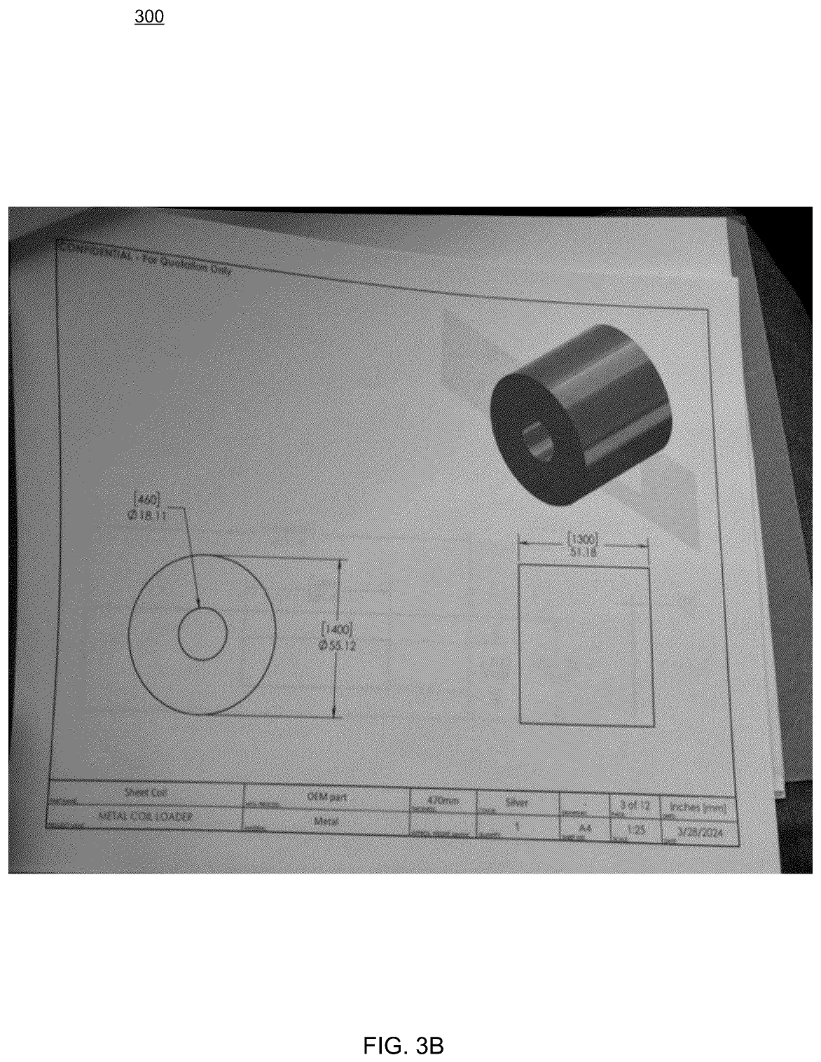

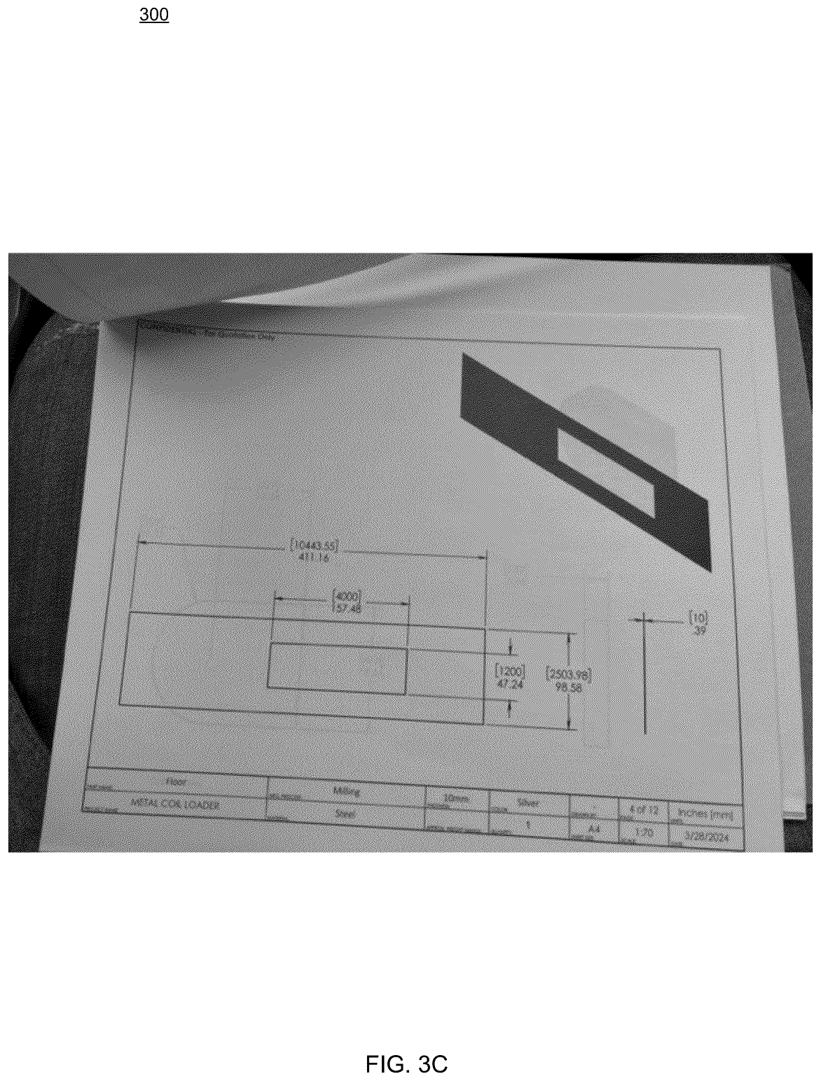

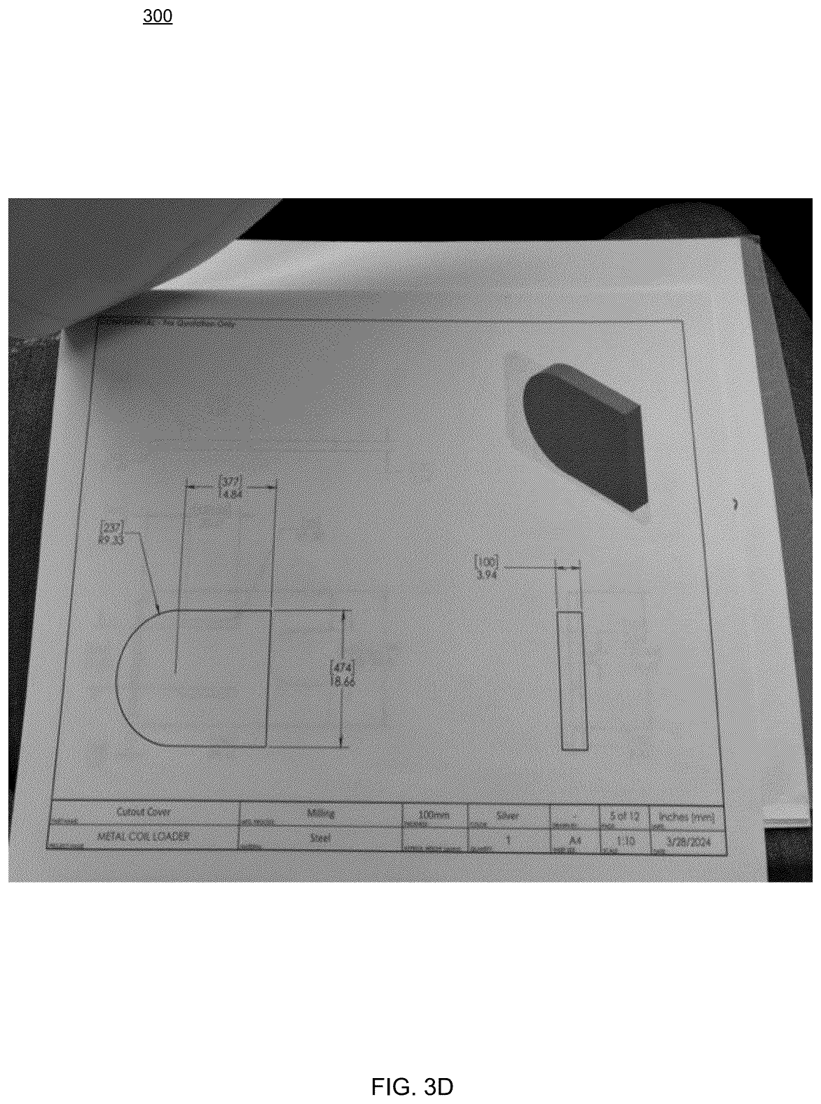

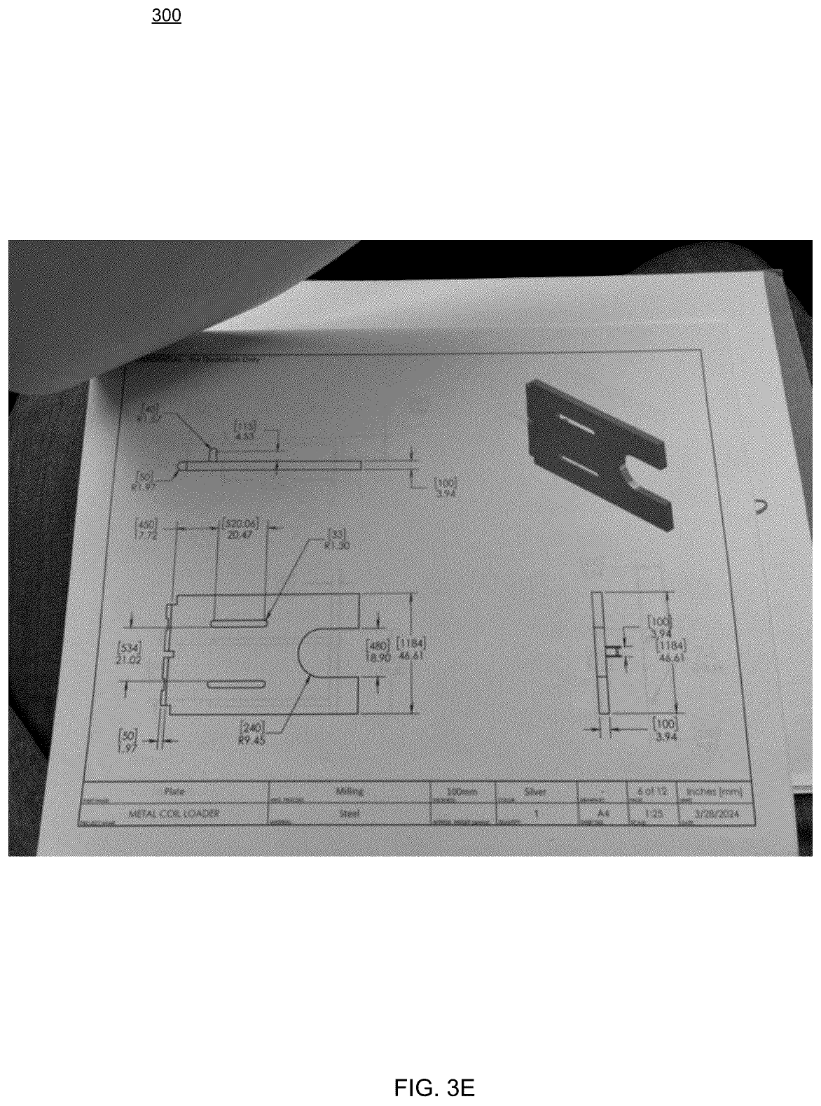

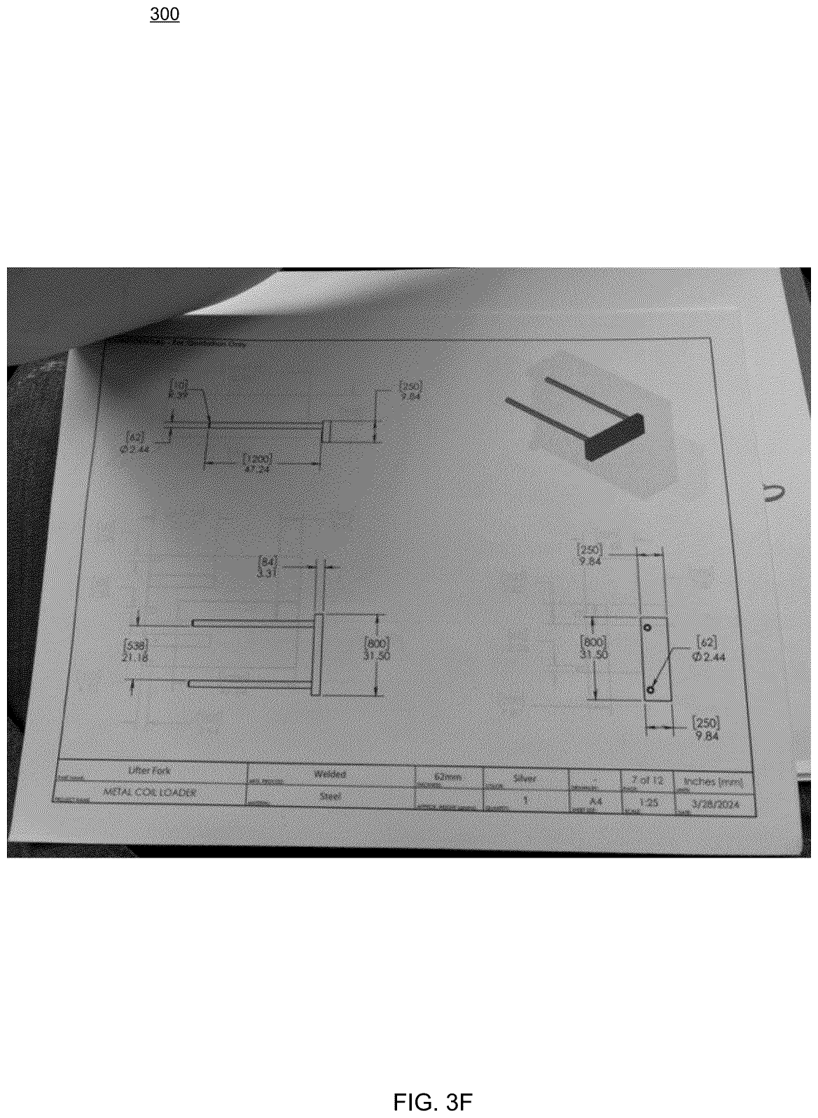

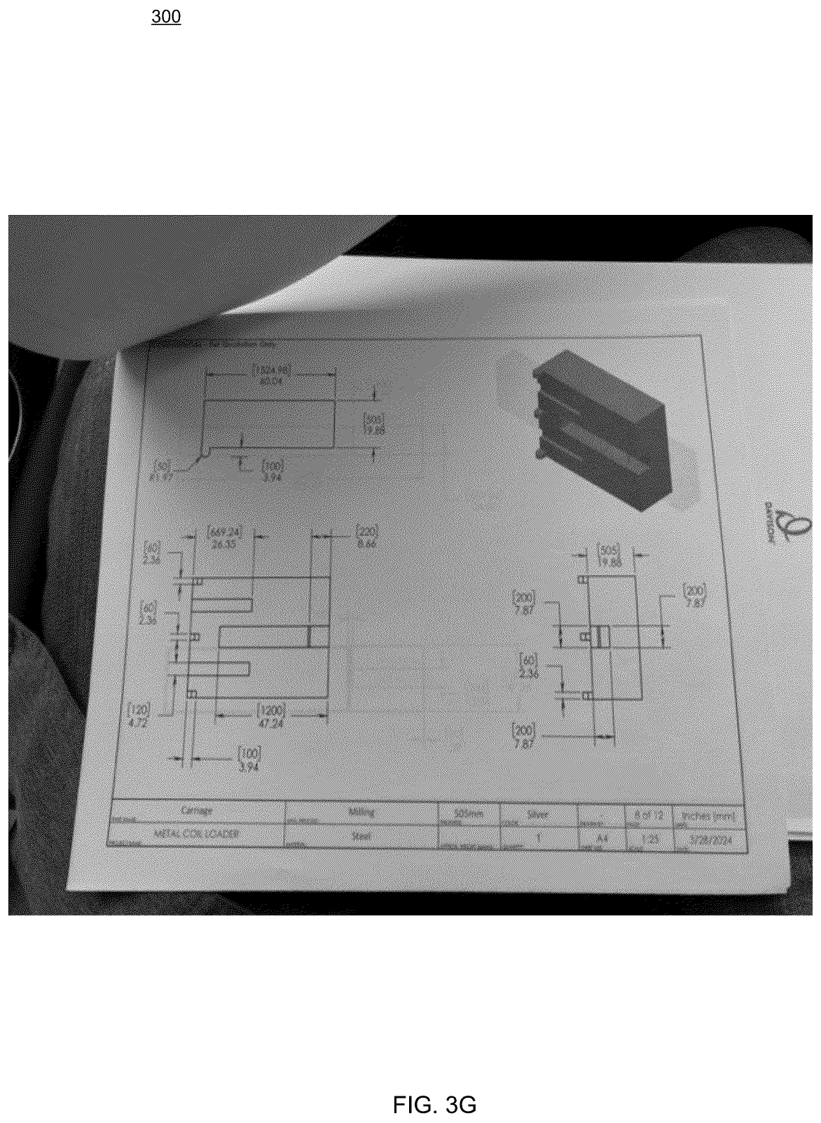

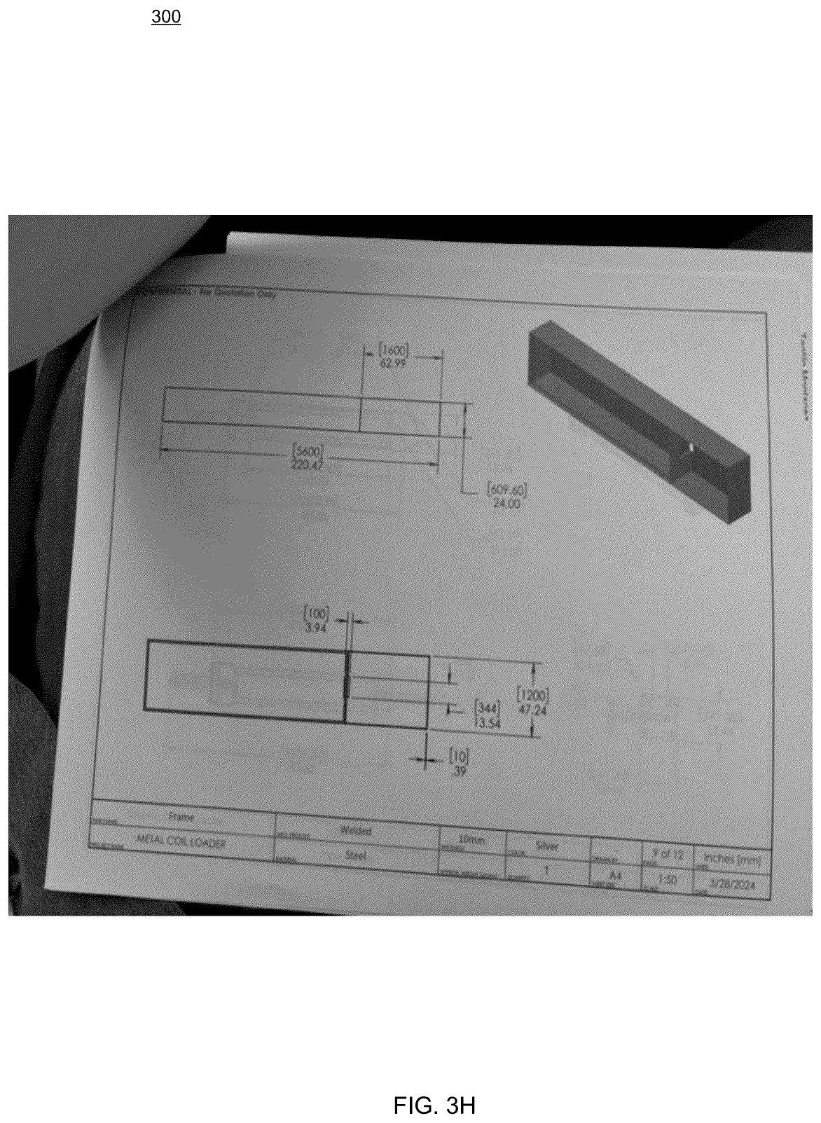

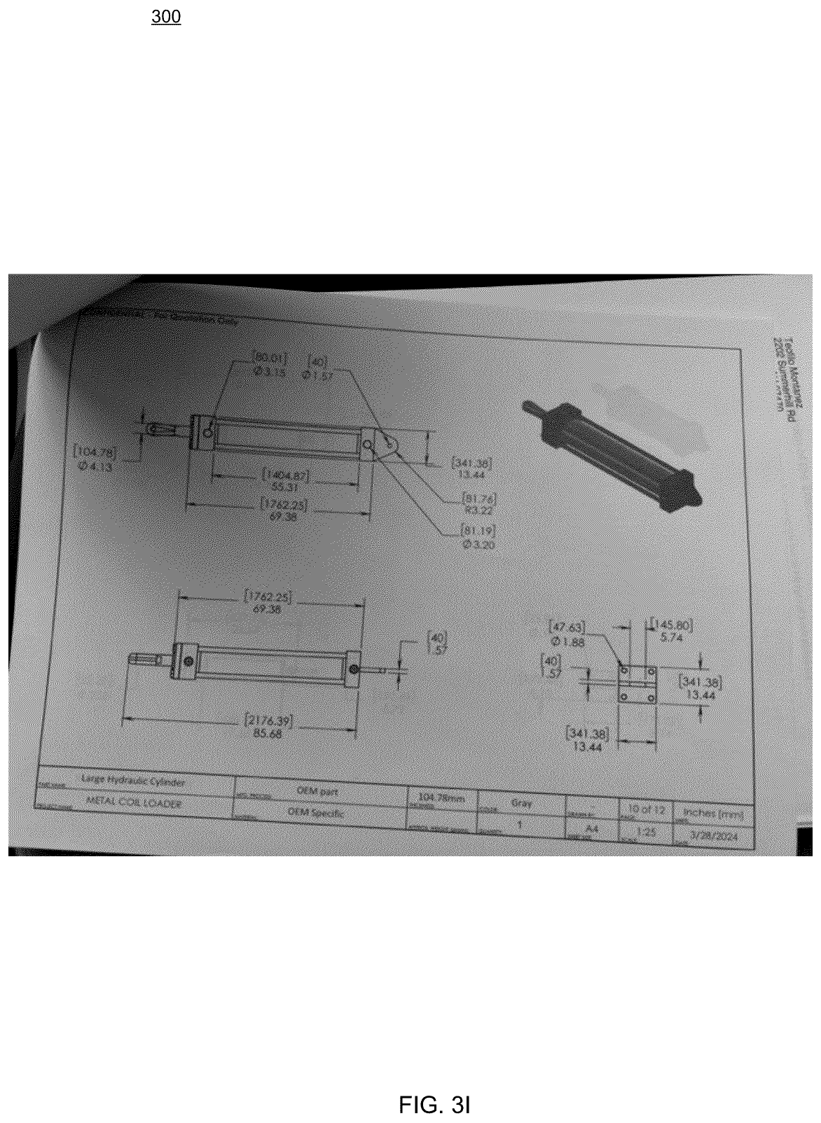

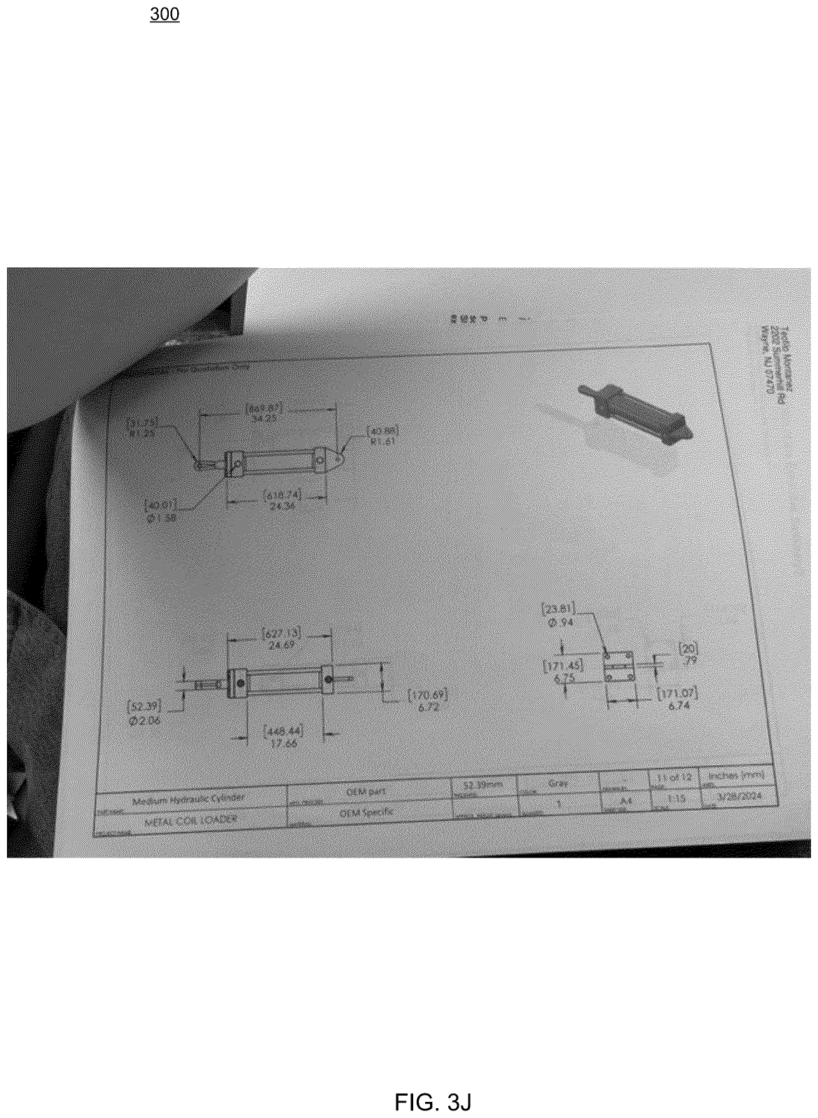

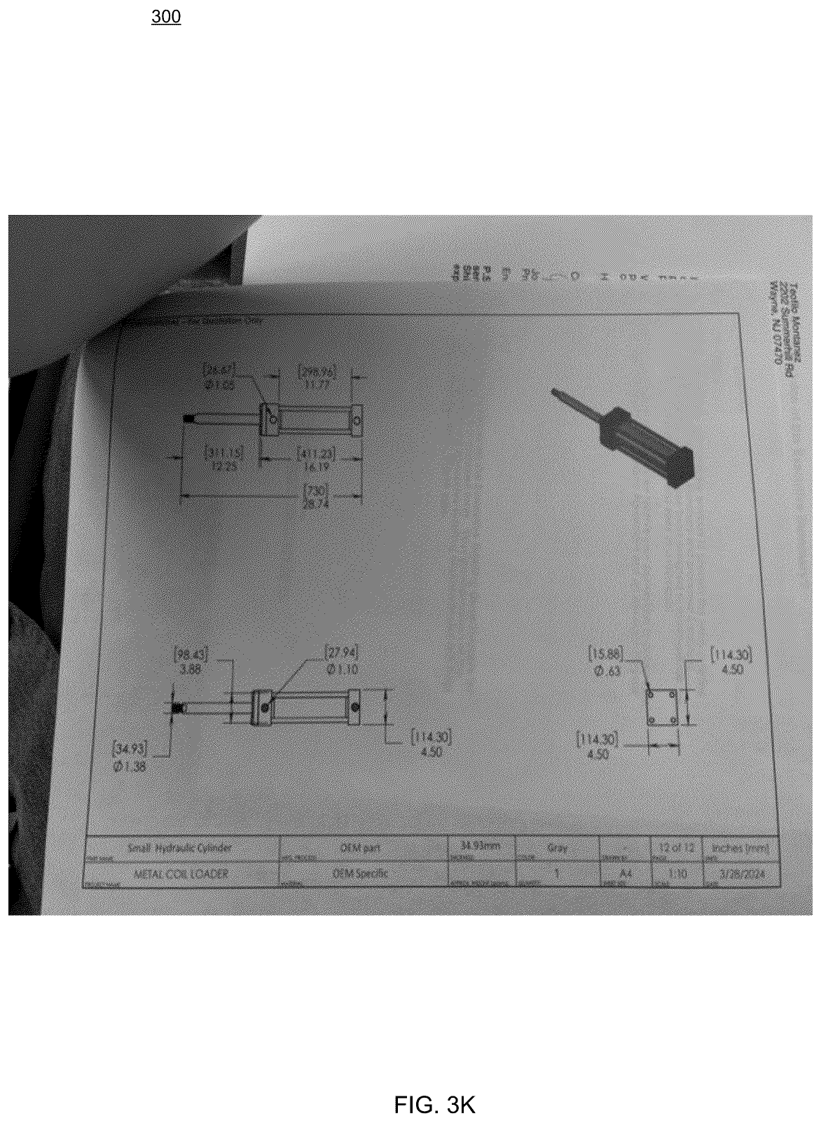

FIG. 3A to 3K illustrates a perspective view of each of the individual parts of the safety-enhanced hydraulic metal coil loading system, in accordance with an embodiment of the present invention.

FIG. 3A illustrates a perspective view of decoiler machine, in accordance with an embodiment of the present invention.

FIG. 3B illustrates a perspective view of sheet coil, in accordance with an embodiment of the present invention.

FIG. 3C illustrates a perspective view of floor, in accordance with an embodiment of the present invention.

FIG. 3D illustrates a perspective view of cutout cover, in accordance with an embodiment of the present invention.

FIG. 3E illustrates a perspective view of plate, in accordance with an embodiment of the present invention.

FIG. 3F illustrates a perspective view of lifter fork, in accordance with an embodiment of the present invention.

FIG. 3G illustrates a perspective view of carriage, in accordance with an embodiment of the present invention.

FIG. 3H illustrates a perspective view of frame, in accordance with an embodiment of the present invention.

FIG. 3I illustrates a perspective view of large hydraulic cylinder, in accordance with an embodiment of the present invention.

FIG. 3J illustrates a perspective view of medium hydraulic cylinder, in accordance with an embodiment of the present invention.

FIG. 3K illustrates a perspective view of small hydraulic cylinder, in accordance with an embodiment of the present invention.

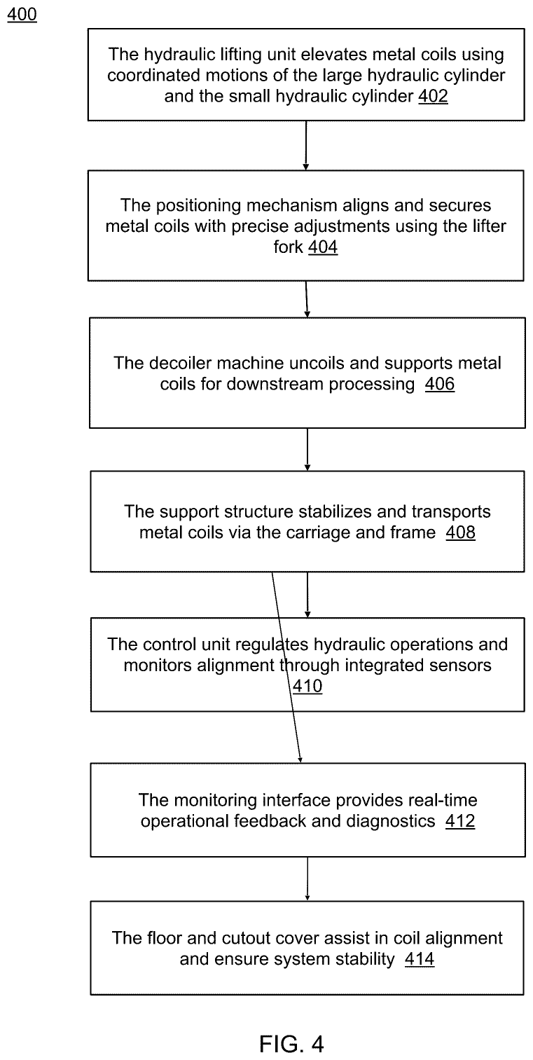

FIG. 4 illustrates a flowchart of a safety-enhanced hydraulic metal coil loading system, in accordance with an embodiment of the present invention.

At 402, the hydraulic lifting unit elevates metal coils using coordinated motions of the large hydraulic cylinder and the small hydraulic cylinder.

At 404, the positioning mechanism aligns and secures metal coils with precise adjustments using the lifter fork.

At 406, the decoiler machine uncoils and supports metal coils for downstream processing.

At 408, the support structure stabilizes and transports metal coils via the carriage and frame.

At 410, the control unit regulates hydraulic operations and monitors alignment through integrated sensors.

At 412, the monitoring interface provides real-time operational feedback and diagnostics.

At 414, the floor and cutout cover assist in coil alignment and ensure system stability.

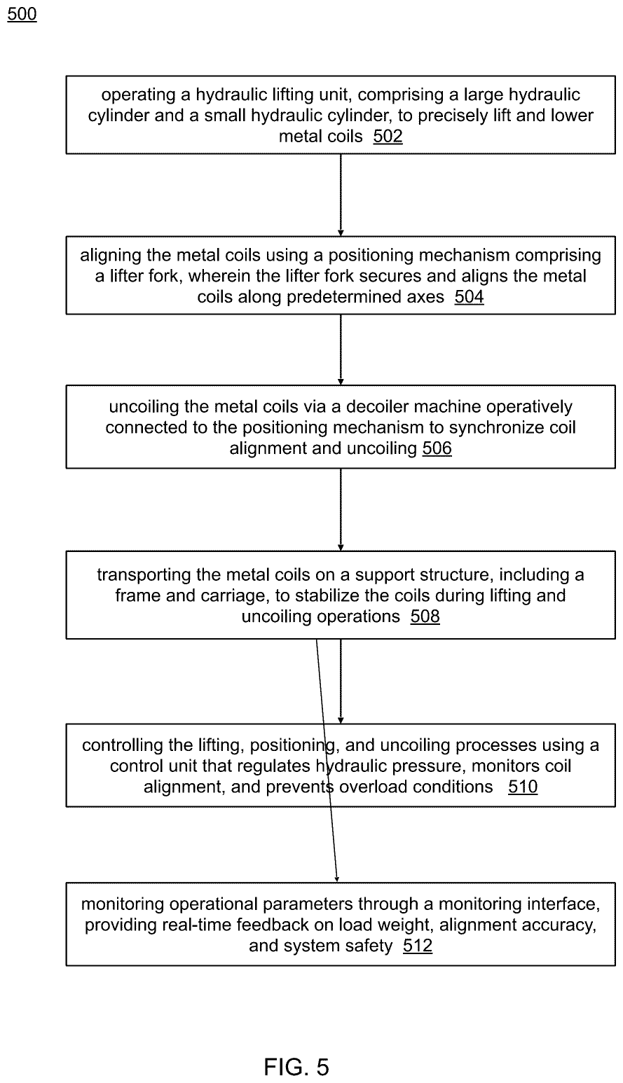

FIG. 5 illustrates a flowchart of a safety-enhanced hydraulic metal coil loading method, in accordance with an embodiment of the present invention.

At 502, operating a hydraulic lifting unit, comprising a large hydraulic cylinder and a small hydraulic cylinder, to precisely lift and lower metal coils.

At 504, aligning the metal coils using a positioning mechanism comprising a lifter fork, wherein the lifter fork secures and aligns the metal coils along predetermined axes.

At 506, uncoiling the metal coils via a decoiler machine operatively connected to the positioning mechanism to synchronize coil alignment and uncoiling.

At 508, transporting the metal coils on a support structure, including a frame and carriage, to stabilize the coils during lifting and uncoiling operations.

At 510, controlling the lifting, positioning, and uncoiling processes using a control unit that regulates hydraulic pressure, monitors coil alignment, and prevents overload conditions.

At 512, monitoring operational parameters through a monitoring interface, providing real-time feedback on load weight, alignment accuracy, and system safety.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. A safety-enhanced hydraulic metal coil loading system, the system comprising:
a hydraulic lifting unit configured to elevate metal coils, the hydraulic lifting unit including a large hydraulic cylinder and a small hydraulic cylinder to enable precise lifting and lowering motions;
a positioning mechanism mechanically linked to the hydraulic lifting unit, the positioning mechanism including a lifter fork for securing and aligning the metal coils along predetermined axes;
a decoiler machine operatively connected to the positioning mechanism, the decoiler machine configured to support and uncoil the metal coils for further processing;
a support structure comprising a frame and a carriage, the support structure configured to stabilize and transport the metal coils during operation;
a control unit electrically coupled to the hydraulic lifting unit, positioning mechanism, and decoiler machine, the control unit programmed to regulate lifting operations, monitor alignment, and prevent overload conditions;
a monitoring interface in communication with the control unit, the monitoring interface configured to provide real-time feedback on operational parameters, including load weight, positioning accuracy, and safety status; and
a floor with a cutout cover secured below the frame to enhance system stability and facilitate coil positioning during loading operations.

2. The system of claim 1, wherein the hydraulic lifting unit incorporates pressure sensors that relay real-time data to the control unit to optimize lifting performance.

3. The system of claim 1, wherein the lifter fork includes motorized clamps adjustable for various coil dimensions, controlled via the monitoring interface.

4. The system of claim 1, wherein the decoiler machine is integrated with sensors to detect coil alignment and synchronize with the positioning mechanism for seamless operation.

5. The system of claim 1, wherein the support structure includes a carriage equipped with shock absorbers to dampen vibrations during operation.

6. The system of claim 1, wherein the control unit includes a wireless interface for remote operation and diagnostics.

7. The system of claim 1, wherein the monitoring interface is a touchscreen panel displaying safety alerts, alignment metrics, and system diagnostics.

8. The system of claim 1, wherein the hydraulic lifting unit is integrated with a fail-safe mechanism to lock the system in position during emergencies.

9. The system of claim 1, wherein the control unit is configured to autonomously adjust hydraulic pressure, lifter fork positioning, and decoiler machine operations based on pre-programmed parameters to ensure optimal performance.

10. The system of claim 1, wherein the floor and cutout cover are integrated with guide rails to assist in precisely aligning the carriage and frame during coil positioning and lifting operations, enabling enhanced stability and reducing operational errors.

11. The system of claim 1, wherein the lifter fork includes integrated load sensors that communicate with the control unit to adjust the lifting force dynamically, preventing coil deformation during handling.

12. The system of claim 1, wherein the large hydraulic cylinder incorporates an energy recovery mechanism that stores excess hydraulic pressure generated during descent for reuse, increasing system energy efficiency.

13. The system of claim 1, wherein the decoiler machine is operatively connected to a medium hydraulic cylinder, enabling synchronized movements to support seamless uncoiling and transfer of the metal coils.

14. The system of claim 1, wherein the control unit employs an artificial intelligence-based algorithm to analyse real-time operational data, including sensor feedback, to optimize hydraulic pressure and adjust the positioning mechanism for variable coil sizes.

15. The safety-enhanced hydraulic metal coil loading method, the method comprising:
operating a hydraulic lifting unit, comprising a large hydraulic cylinder and a small hydraulic cylinder, to precisely lift and lower metal coils;
aligning the metal coils using a positioning mechanism comprising a lifter fork, wherein the lifter fork secures and aligns the metal coils along predetermined axes;
uncoiling the metal coils via a decoiler machine operatively connected to the positioning mechanism to synchronize coil alignment and uncoiling;
transporting the metal coils on a support structure, including a frame and carriage, to stabilize the coils during lifting and uncoiling operations;
controlling the lifting, positioning, and uncoiling processes using a control unit that regulates hydraulic pressure, monitors coil alignment, and prevents overload conditions; and
monitoring operational parameters through a monitoring interface, providing real-time feedback on load weight, alignment accuracy, and system safety.

16. The method of claim 15, wherein the method further comprises the step of dynamically adjusting the lifting force of the hydraulic lifting unit based on feedback from integrated load sensors in the lifter fork, preventing coil deformation.

17. The method of claim 15, wherein the method further comprises storing and reusing excess hydraulic pressure from the large hydraulic cylinder during descent, via an energy recovery mechanism, to enhance energy efficiency.

18. The method of claim 15, wherein the method further comprises analysing real-time operational data through the control unit employing an artificial intelligence-based algorithm, optimizing hydraulic pressure and positioning for variable coil sizes.
